(19) United States
(12) Patent Application Publication
(10) Pub. No.: US 2026/0362359 A1
(43) Pub. Date: Nov. 12, 2026

(54) CONNECTED MODE MOBILITY MANAGEMENT FOR GROUP OF USERS IN A VEHICLE AND SERVED BY NON-TERRESTRIAL NETWORK DEPLOYMENTS

(71) Applicant: Nokia Technologies Oy, Espoo (FI)

(72) Inventors: Rajesh Babu NATARAJAN, Bangalore (IN); Subramanya CHANDRASHEKAR, Bangalore (IN); Srinivasan SELVAGANAPATHY, Bangalore (IN); Saurabh KHARE, Bangalore (IN); Devaki CHANDRAMOULI, Dallas, TX (US)

(21) Appl. No.: 19/125,125

(22) PCT Filed: Nov. 4, 2022
(86) PCT No.: PCT/EP2022/080846

§ 371 Date: Apr. 28, 2025

(51) Int. Cl. H04W 60/04; H04B 7/185; H04L 41/50; H04W 4/40

(52) U.S. Cl. CPC H04W 60/04; H04B 7/18556; H04L 41/5058; H04W 4/40

(57) ABSTRACT

Systems, methods, apparatuses, and computer program products for connected mode mobility management for group of users in a vehicle and served by the non-terrestrial network deployments are provided. For example, a method can include a network deriving common mobility assistance information based on a non-terrestrial network radio access node's ephemeris data and travel path information of a vehicle transporting a group of user equipment. The travel path information may be provided by an application function. The network may handle handover of the group of user equipment within the vehicle based on grouping them together.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing connected mode mobility management for aerial vehicle/cruise ship and non-terrestrial network deployments.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IOT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least memory including computer program. The at least one memory and the computer program can be configured to, with the at least one processor, cause the apparatus at least to perform sending, upon startup of the apparatus, a setup request to a control plane function of a core network. The setup request can include ephemeris data of the apparatus.

An embodiment may be directed to an apparatus. The apparatus can include at least one processor and at least memory including computer program. The at least one memory and the computer program can be configured to, with the at least one processor, cause the apparatus at least to perform receiving a setup request from a radio access network node. The setup request can include ephemeris data of the radio access network node. The apparatus can also perform providing a setup response to the radio access network node in response to the setup request.

An embodiment may be directed to an apparatus. The apparatus can include at least one processor and at least memory including computer program. The at least one memory and the computer program can be configured to, with the at least one processor, cause the apparatus at least to perform sending a registration request from a user equipment associated with a vehicle to a radio access network. The apparatus can also perform receiving a registration response that can include an identifier assigned to the vehicle user equipment.

An embodiment may be directed to an apparatus. The apparatus can include at least one processor and at least memory including computer program. The at least one memory and the computer program can be configured to, with the at least one processor, cause the apparatus at least to perform obtaining, from a vehicle user equipment, an identifier assigned to the vehicle user equipment. The apparatus can also perform registering for services with a network. The registering can include providing the identifier to the network in the registration request.

An embodiment may be directed to an apparatus. The apparatus can include at least one processor and at least memory including computer program. The at least one memory and the computer program can be configured to, with the at least one processor, cause the apparatus at least to perform receiving, from a vehicle user equipment, a non-access stratum message with a registration request. The at least one memory and the computer program can further be configured to, with the at least one processor, cause the apparatus at least to perform sending a registration request to a control plane function of a core network. The registration request can include an identifier of a vehicle user equipment. The apparatus can also perform receiving an initial context setup request in response to the registration request. The initial context setup request can include common mobility assistance information corresponding to the identifier.

An embodiment may be directed to an apparatus. The apparatus can include at least one processor and at least memory including computer program. The at least one memory and the computer program can be configured to, with the at least one processor, cause the apparatus at least to perform receiving a request to provide common mobility assistance information associated with an identifier of the vehicle user equipment. The apparatus can also include providing the common mobility assistance information to a control plane function in response to the request.

An embodiment may be directed to an apparatus. The apparatus can include at least one processor and at least memory including computer program. The at least one memory and the computer program can be configured to, with the at least one processor, cause the apparatus at least to perform obtaining, from an application function, trajectory path or travel details corresponding to a user equipment associated with an identifier of a vehicle user equipment. The apparatus can also perform providing, to an analytics function, the trajectory path or travel details corresponding to the identifier.

An embodiment may be directed to an apparatus. The apparatus can include at least one processor and at least memory including computer program. The at least one memory and the computer program can be configured to, with the at least one processor, cause the apparatus at least to perform obtaining trajectory path or travel details corresponding to an identifier of a vehicle user equipment. The apparatus can also perform providing, to a network exposure function, the trajectory path or travel details corresponding to the identifier.

An embodiment may be directed to a method. The method can include sending, by a non-terrestrial network access node upon startup of the non-terrestrial network access node,, a setup request to a control plane function of a core network. The setup request can include ephemeris data of the non-terrestrial network access node.

An embodiment may be directed to a method. The method can include receiving a setup request from a radio access network node. The setup request can include ephemeris data of the radio access network node. The method can also include providing a setup response to the radio access network node in response to the setup request.

An embodiment may be directed to a method. The method can include sending, from a vehicle user equipment, a registration request from a user equipment associated with a vehicle to a radio access network. The method can also include receiving, by the vehicle user equipment, a registration response that can include an identifier assigned to the vehicle user equipment.

An embodiment may be directed to a method. The method can include obtaining, by a user equipment from a vehicle user equipment, an identifier assigned to the user equipment carrier. The method can also include registering, by the user equipment, for services with a network. The registering can include providing the identifier to the network in the registration request.

An embodiment may be directed to a method. The method can include receiving, at a radio access node from a vehicle user equipment, a non-access stratum message with a registration request. The method can further include sending, by a radio access node, a registration request to a control plane function of a core network. The registration request can include an identifier of a vehicle user equipment. The method can also include receiving an initial context setup request in response to the registration request. The initial context setup request can include common mobility assistance information corresponding to the identifier.

An embodiment may be directed to a method. The method can include receiving a request to provide common mobility assistance information associated with an identifier of a vehicle user equipment. The method can also include providing the common mobility assistance information to a control plane function in response to the request.

An embodiment may be directed to a method. The method can include obtaining, from an application function, trajectory path or travel details corresponding to a user equipment associated with a vehicle user equipment identifier. The method can also include providing, to an analytics function, the trajectory path or travel details corresponding to an identifier of a vehicle user equipment.

An embodiment may be directed to a method. The method can include obtaining trajectory path or travel details corresponding to an identifier of a vehicle user equipment. The method can also include providing, to a network exposure function, the trajectory path or travel details corresponding to the identifier.

An embodiment may be directed to an apparatus. The apparatus can include means for sending a setup request to a control plane function of a core network upon startup of the apparatus. The setup request can include ephemeris data of the apparatus.

An embodiment may be directed to an apparatus. The apparatus can include means for receiving a setup request from a radio access network node. The setup request can include ephemeris data of the radio access network node. The apparatus can also include means for providing a setup response to the radio access network node in response to the setup request.

An embodiment may be directed to an apparatus. The apparatus can include means for receiving, at a radio access node from a vehicle user equipment, a non-access stratum message with a registration request. The apparatus can further include means for sending, from a vehicle user equipment, a registration request from a user equipment associated with a vehicle to a radio access network. The apparatus can also include means for receiving, by the vehicle user equipment, a registration response that can include an identifier assigned to the vehicle user equipment.

An embodiment may be directed to an apparatus. The apparatus can include means for obtaining, by a user equipment from a vehicle user equipment, an identifier assigned to the vehicle user equipment. The apparatus can also include means for registering, by the user equipment, for services with a network. The registering can include providing the identifier to the network in the registration request.

An embodiment may be directed to an apparatus. The apparatus can include means for sending a registration request to a control plane function of a core network. The registration request can include an identifier of a vehicle user equipment. The apparatus can also include means for receiving an initial context setup request in response to the registration request. The initial context setup request can include common mobility assistance information corresponding to the identifier.

An embodiment may be directed to an apparatus. The apparatus can include means for receiving a request to provide common mobility assistance information associated with an identifier of a vehicle user equipment. The apparatus can also include means for providing the common mobility assistance information to a control plane function in response to the request.

An embodiment may be directed to an apparatus. The apparatus can include means for obtaining, from an application function, trajectory path or travel details corresponding to a user equipment associated with an identifier of a vehicle user equipment. The apparatus can also include means for providing, to an analytics function, the trajectory path or travel details corresponding to the identifier.

An embodiment may be directed to an apparatus. The apparatus can include means for obtaining trajectory path or travel details corresponding to an identifier of a vehicle user equipment. The apparatus can also include means for providing, to a network exposure function, the trajectory path or travel details corresponding to the identifier.

### BRIEF DESCRIPTION OF THE DRAWINGS

For proper understanding of example embodiments, reference should be made to the accompanying drawings, wherein:

FIG. 1A illustrates the provision of access services to a user equipment using a non-terrestrial network;

FIG. 1B illustrates parameters for ephemeris;

FIG. 2 illustrates network exposure function service operations information flow;

FIG. 3 illustrates a non-terrestrial network next generation node B updating its ephemeris data to the core network, according to certain embodiments;

FIG. 4 illustrates a registration procedure for a vehicle user equipment of a vehicle used to carry other user equipment, according to certain embodiments;

FIG. 5 illustrates provision of travel details and common group identifier for user equipment traveling together, according to certain embodiments;

FIG. 6 illustrates an application provisioning a common identifier, such as a common vehicle identifier, for all onboard user equipment, according to certain embodiments;

FIG. 7 illustrates a proximity services discovery procedure, according to certain embodiments;

FIG. 8 illustrates a registration procedure of an onboard user equipment, according to certain embodiments;

FIG. 9 illustrates updating common mobility assistance information, according to certain embodiments;

FIG. 10 illustrates usage of common mobility assistance information, according to certain embodiments; and

FIG. 11 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing connected mode mobility management for aerial vehicle/cruise ship and non-terrestrial network deployments, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

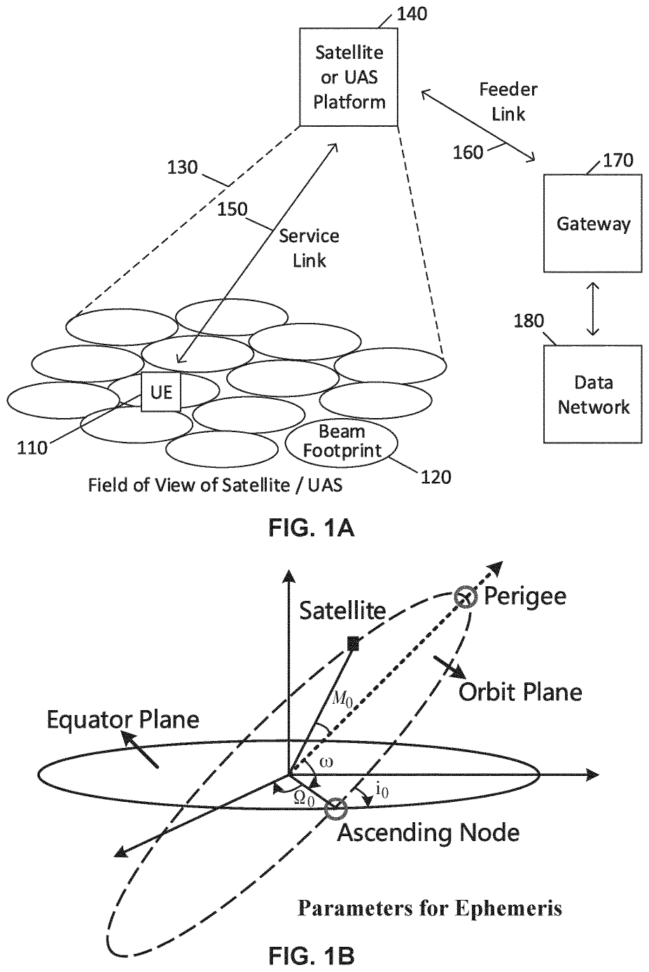

A non-terrestrial network can be a network or a segment of a network, which can use radio frequency (RF) resources on board a satellite or unmanned aerial system (UAS) platform. FIG. 1A illustrates the provision of access services to a user equipment using a non-terrestrial network.

As shown in FIG. 1A, a UE 110 can be within one of many beam footprints 120 within a field of view 130 of a satellite or UAS platform 140. The wireless connection between UE 110 and satellite or UAS platform 140 can be referred to as a service 150. Feeder link 160 can connect the satellite or OAS platform 140 to a gateway 170, which can connect to a data network 180.

There are a variety of types of non-terrestrial network (NTN) platforms. The platforms can include low-Earth orbit (LEO) satellite, medium-Earth orbit (MEO) satellite, geostationary Earth orbit (GEO), UAS platform including high-altitude platform system (HAPS), and high elliptical orbit (HEO) satellite. LEO and MEO satellites may have an effectively circular orbit around the Earth. GEO satellites and UAS platforms may have an essentially fix position with respect to the Earth. HEO satellites may have an elliptical satellite.

Altitude ranges and beam footprint sizes may vary for different platforms. LEO satellites may have an altitude range of 300 km to 1500 km and a beam footprint size of 100 km to 1000 km. MEO satellites may have an altitude range of 7000 km to 25000 km and a beam footprint size of 100 km to 1000 km. GEO satellites may have an altitude of about 35,786 km and a typical beam footprint size of 200 km to 3500 km. A UAS platform can have an altitude range of 8 km to 50 km with about 20 km for HAPS. Typical UAS platform beam footprint size can be 5 km to 200 km. HEO satellites can have an altitude range of 400 km to 50000 km and a beam footprint size of 200 km to 3500 km.

GEO satellites and UAS may be used to provide continental, regional, or local service. A constellation of LEO and MEO satellites can be used to provide services in both Northern and Southern hemispheres. In some case, the constellation can even provide global coverage including polar regions. For the latter, an appropriate orbit inclination can be used, sufficient beams generated, and inter-satellite links relied-upon.

FIG. 1B illustrates parameters for ephemeris. As shown in FIG. 1B, the position of a satellite can be described in terms of a relationship between an orbit plane and the equator plane, and an angular position around a circle or ellipsis in the orbit plane. The orbit plane may be described in terms of multiple angle offsets from the equator plane. In the case of an elliptical orbit, the shape of the orbit may also be defined in terms of an apogee or perigee of the orbit.

Ephemeris data can include information about the orbital trajectories of artificial satellites. There are different possible representations of ephemeris data. One possibility is to use orbital parameters, such as semi-major axis, eccentricity, inclination, right ascension of the ascending node, argument of periapsis, mean anomaly at a reference point in time, and the epoch. The first five parameters can determine an orbital plane, and the other two parameters can be used to determine exact satellite location at a time.

The orbital plane parameters can include the following: √a, the square root of a semi-major axis; e, the eccentricity; i_0, inclination angle at a reference time; Ω_0, longitude of ascending node of orbit plane or right ascensions of the ascending node; and ω, the argument of perigee or argument of periapsis. Satellite level parameters can include the following: M_0, mean anomaly at a reference time or a true anomaly and a reference point in time; and t_Oe, ephemeris reference time or epoch.

There may be at least two ways to provide orbital parameters per satellite. One way may be to pre-provision satellite level orbital parameters for all the satellites that may serve the UE in the universal subscriber identity model (USIM)/UE and the ephemeris data for each satellite can be linked to a satellite ID or index. In this approach the satellite ID or index of the serving satellite in system information can be broadcast so that the UE is able to find the corresponding detailed ephemeris data stored in uSIM to derive the position coordinates of the serving satellite. The satellite ID or index of neighbour satellites can also be provided to UE via system information or dedicated RRC signaling to assist mobility handling.

Another way is to broadcast satellite level orbital parameters of the serving satellite in system information. The UE can derive the position coordinates of the serving satellite. The ephemeris data of the neighboring satellites can also be provided to the UE via system information or dedicated radio resource control (RRC) signaling. If the baseline orbital plane parameters are provisioned in uSIM/UE, only mean anomaly at a reference point in time and the epoch may be broadcasted to the UE, thereby reducing signaling overhead.

The network exposure function (NEF) can support external exposure of capabilities of network functions. External exposure can be categorized as monitoring capability, provisioning capability, policy/charging capability, network status reporting capability, and analytics reporting capability. The monitoring capability can be for monitoring of specific event for UE in the fifth generation (5G) system (5GS) and making such monitoring events information available for external exposure via the NEF. The provisioning capability can be for allowing an external party to provision information that can be used for the UE in 5GS. The policy/charging capability can be for handling quality of service (QoS) and charging policy for the UE based on the request from external party. The analytics capability can be to allow an external party to acquire analytics information generated by the 5G system.

The details for the external exposure of analytics capabilities, as well as interactions between NEF, external party and the network data analytics function (NWDAF) are described in third generation partnership project (3GPP) technical specification (TS) 23.288.

Provisioning capability can allow an external party to provision the information, such as expected UE behavior and service specific parameters or the 5G virtual network (VN) group information to 5G network functions. In the case of provisioning the expected UE behavioral information, the expected UE behavioral information includes information on expected UE movement and communication characteristics. In the case of provisioning the 5G VN group information the provisioning information includes information on the 5G VN group. The service specific information includes information to support the specific service in the 5G system. Provisioned data can be used by the other network functions (NFs).

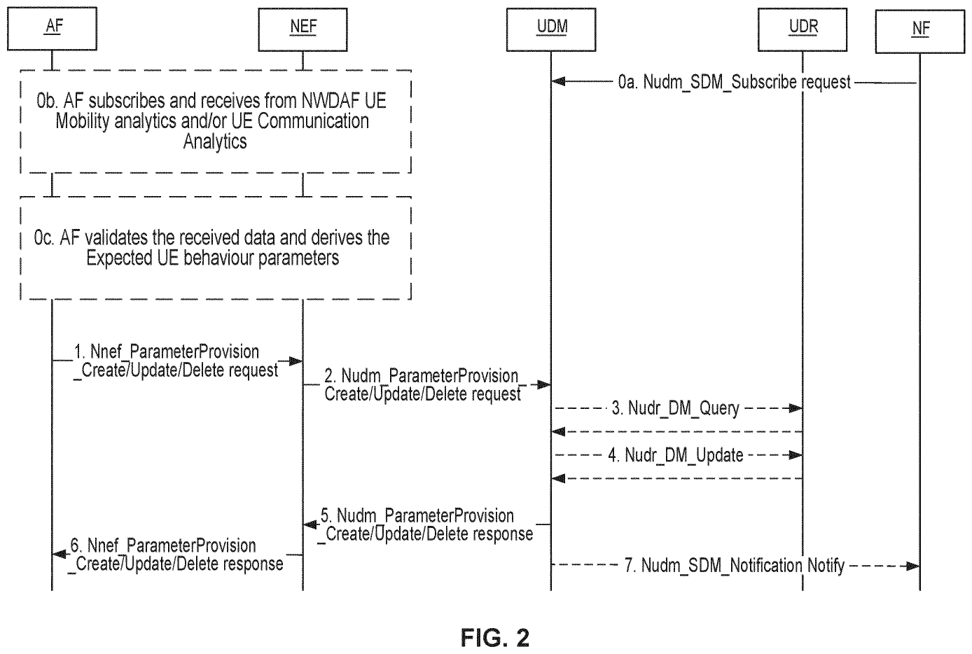

FIG. 2 illustrates network exposure function service operations information flow. As shown in FIG. 2, at 0a, a subscribe request can be sent from a network function to unified data management (UDM). Meanwhile at 0b, the application function (AF) can subscribe and receive from NWDAF UE mobility analytics and/or UE communication analytics. Likewise, at 0c, AF can validate the received data and can derive the expected UE behavior parameters.

At 1, the AF can send a provisioning request to the NEF. At 2, the NEF can similarly send the provisioning request to the UDM. The UDM can send a query at 3and can request an update at 4. At 5, the UDM can provide a response to the NEF. In turn, at 6, the NEF can provide a response to the AF. Further, at 7, the UDM can notify the NF.

Various use cases can be considered. For example, an aircraft can carry passengers and cross oceans. In this case, there may be no terrestrial network capable of directly serving the users that are passengers. Thus, the users may be best served by a non-terrestrial network.

Satellite based base stations may be in constant motion with respect to stationary UEs. This motion may be further complicated by the UEs own movement. It may, therefore, be valuable to manage connected mobility efficiently.

In a particular example an NTN gNB may be serving an aerial vehicle (AV), such as an Aircraft, or a ship, such as a cruise ship, and the mobility complexity of UEs inside the aircraft or ship may be compounded because of high-speed mobility of NTN cells and as well as the fast moving UEs of the AV.

The connected mode functionality including mobility may have significant performance impacts due to factors like the movement of the users and the satellite. There is a potential scope for optimization of signaling aspects for connected mode mobility of UEs inside the AV or ship. Any transportation system that can provide transportation for multiple UEs can be viewed as a carrier vehicle. Carrier vehicles can broadly encompass trains, monorails, lighter-than-air flying vehicles such as blimps and dirigibles, heavier than-air flying vehicles such as helicopters and airplanes, and other mass transit vehicles such as buses and trams. Although certain embodiments can be applied to all these scenarios, long haul carrier vehicles with large numbers of on board UEs, such as high speed trains, airplanes, and cruise ships may particularly benefit from certain embodiments.

Certain embodiments provide a mechanism to build mobility assistance information for optimized connected mode functionality and mobility based on combination of satellite information and AV mobility information. Although AV mobility is mentioned as an example, any vehicle mobility information may be provided, even if the vehicle is a ship or other non-aerial vehicle. Likewise, while an AV identifier is provided as an example, any vehicle identifier or vehicular identifier can be used.

Certain embodiments relate to the preparation of common mobility assistance information for all UEs of an AV connected to an NTN gNB. More particularly, certain embodiments relate to usage of the ephemeris data of the cells connected to a NTN-gNB/Satellite Node B(sNB). Furthermore, certain embodiments relate to usage of pre-determined and real time information of an aircraft trajectory path. Also, certain embodiments relate to association of AV, such as commercial passenger aircraft, with the individual UEs inside the AV. Certain embodiments relate to derivation of common mobility assistance information and usage for connected mode mobility at NTN gNB.

Additionally, certain embodiments relate to enhancements of connected mode operation of UEs in an AV using the common mobility assistance information. For example, certain embodiments relate to enhanced connected mode operation with reduced/disabled GNSS assistance for AV UEs. Additionally, certain embodiments relate to optimized handover of AV UEs with distributed signaling load based on common mobility assistance information.

In the following discussion, an application function (AF) can be a function provided by a service provider, such as a service provider that provides service in the aircraft/ship to all the subscribers to the service in the aircraft. Note that here and in the following discussion, aircraft and/or ships are used as examples, but certain embodiments may apply more broadly to any carrier vehicle, as described above.

The AV, such as an aircraft, can be considered to be a single UE acting as a gateway or host for multiple individual UEs, and can be referred to as a vehicle UE. This AV can also be embedded with a UE device for the AV's communication with the network.

Preparation of common mobility assistance information for all UEs of an AV connected to an NTN gNB can include various aspects. For example, certain embodiments relate to usage of the ephemeris data of the cells connected to a NTN-gNB/sNB. In certain embodiments, the ephemeris data of all cells of the NTN-gNB/sNB can be shared with AMF via an NG Setup/RAN Configuration update procedure. Any subsequent update in the data can be updated to AMF via RAN configuration update procedure. An AMF can update the info to NWDAF or management data analytics service (MDAS) or a new or existing NF for further analytics.

In another embodiment, an operator can configure this ephemeris data in NWDAF/MDAS/NF via operations, administration, and management (OAM), the ephemeris data for respective NTN-gNB/sNB on applicable NFs, for example AMF/NWDAF.

Certain aspect of certain embodiments may also relate to usage of the pre-determined and real time information of aircraft trajectory path. For example, in certain embodiments a vehicle UE can be pre-configured with a trajectory path that is shared with the AF using an application for trajectory management over the connected network. The AF can use the received data for further analytics. The vehicle UE can also be referred to as a carrier UE, a UE carrier, a vehicular UE, a carrier vehicle UE, a transporter UE, or the like. This vehicle UE may be the aircraft or ship or a module equipped in the aircraft or ship.

The application function, which may for example be managed by the aircraft service provider, can provide the trajectory path of the vehicle UE to the network, such as AMF/NWDAF, based on an event trigger, such as registration of the vehicle UE.

Input to NWDAF/MDAS or new NF would be ephemeris data, vehicle UE trajectory path, and/or time duration of the travel. The ephemeris data can be collected from the AMF or OAM. The ephemeris data may be ephemeris data related to satellites. It could be for a whole public land mobile network (PLMN) or country. The vehicle UE trajectory path can be collected from an application function. The NWDAF or NF can collect this information from the AF via NEF. The vehicle UE trajectory path can be a defined path of the flight/AV with defined halts at defined locations. It can be in the form of 3D waypoints or any other way to define the path. For example, in the case of an aircraft, the vehicle UE trajectory path can be a flight plan. The time duration of the travel can obtained from the AF. Thus, the AF can provide the trajectory path and time windows.

Certain embodiments relate to the association of AV/aircraft with individual UEs inside the AV. For example, the network provider may provide an AF to accumulate information of all associated UEs for a particular travel itinerary. The individual UEs can provide their inputs using the AF and the consolidated details can be available at the AF. The travel itinerary information may include mobile station international subscriber directory number (MS-ISDN). The operator's AF can provide the consolidated information to the NEF using the exposure framework that is subsequently transferred to NWDAF/AMF. This consolidated information can include the mapping between vehicle UE and the individual UEs in the AV. The AMF can inform the RAN about the common AV group UE ID (AVID) and the associated UEs.

In a further embodiment, the network, for example the AMF, can assign an AVID to the vehicle UE during the vehicle UE's initial registration based on new device type indication by the vehicle UE sent by the vehicle UE.

The vehicle UE can share the assigned AVID to onboard UEs via a sidelink (SL)/ProSe Model A discovery procedure, or via non-3GPP access onboard like Wi-Fi or provide a code for manual configuration by the onboard UEs.

The onboard UEs may optionally provide the discovered AVID during their initial registration with the AMF and the AMF may form the association of vehicle UE and onboard UEs and may provide the association information to the RAN. Alternatively, the AMF may be able to associate the onboard UE(s) with the vehicle UE(s) based on the current tracking area code (TAC).

Certain embodiments may relate to deriving common mobility assistance info. For example, in certain embodiments NWDAF/AMF may learn about the pre-determined travel path/details of the vehicle UE, via AMF/AF and correlate with NTN-gNB/sNB ephemeris data to derive common mobility assistance info. The AMF can provide the derived common mobility assistance info to the RAN. The RAN can use common mobility assistance info received for the vehicle UE and based on received AVID can associate the vehicle UE and the onboard UEs. The RAN can use the association for optimizing the connected mode mobility management of the onboard UEs.

Output of NWDAF/MDAS or new NF may be a vehicle UE ID and common mobility assistance information. The common mobility assistance information may include time, predicted UE location, and next predicted network. The predicted assistance information may be used by the RAN to assist in a handover preparation phase. The common mobility assistance information may contain a group of, at a certain time interval, predicted UE location and next predicted network.

Certain embodiments relate to enhancements of connected mode operation of UEs in an AV using the common mobility assistance information. Enhanced connected mode operation with reduced/disabled GNSS assistance for AV UEs may be one aspect.

The vehicle UE may update GNSS assistance information to the network periodically during the travel. The GNSS assistance information can include location, timing, distance from NTN cell, or the like. The GNSS assistance information may enable the network to determine any changes from the pre-determined path/trajectory, that was made available earlier.

The AMF may also associate the GNSS assistance information of the vehicle UE for all individual UEs of the AV. This association may enable the GNSS of all the UEs to be turned OFF during the travel. This association may be shared with the RAN as well.

Optimized handover of AV UEs with distributed signaling load based on common Mobility assistance information may be another aspect. Based on the current location of the vehicle UE, the handover (HO) preparations for all the individual UEs may be prepared against a known target cell in advance. This preparation may ensure minimized signaling load on the target cell and also a reliable HO for all AV UEs.

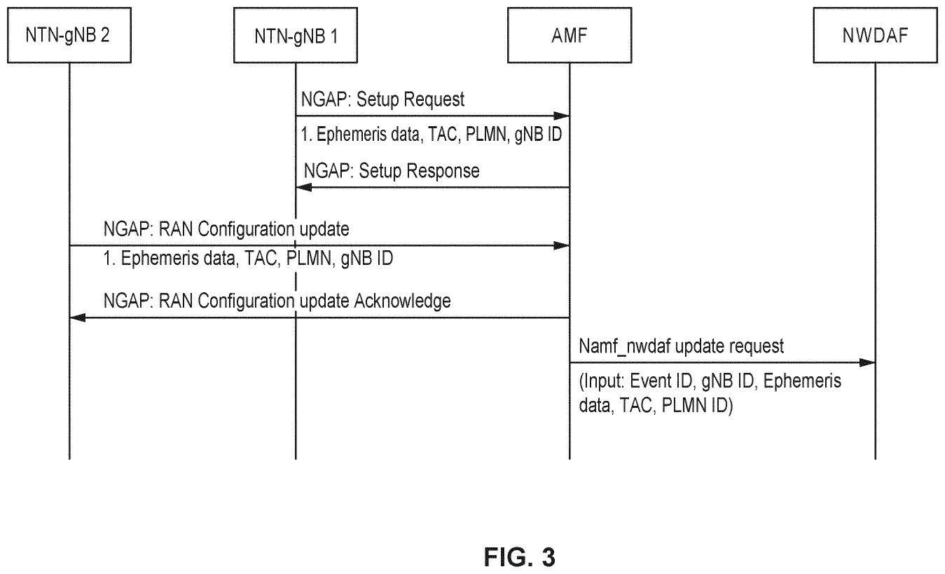

FIG. 3 illustrates a non-terrestrial network next generation node B updating its ephemeris data to the core network, according to certain embodiments. Using the ephemeris data of the NTN-gNB/sNB is illustrated. As shown in FIG. 3, each NTN-gNB can send an NG application protocol (NGAP) setup request that can include the NTN gNB's ephemeris data to the core network (CN). The setup procedure, including the setup request, can be triggered whenever NTN-gNB is commissioned or restarts. The ephemeris data can be accompanied by TAC, PLMN, and gNB ID information. Subsequently, a RAN configuration update can be provided with the same information, as an update, for example from a second NTN-gNB 2.

As indicated in the call flow of FIG. 3, the NTN gNB can be configured with ephemeris data, which can be indicated to the AMF via NG setup procedure and/or RAN configuration update procedure. The AMF can update these data for each of the gNB for a new event ID, which may be ephemeris data for NTN gNB. The AMF can update the NWDAF with the received ephemeris data. Alternatively, not shown, OAM can configure the ephemeris data at the AMF, NWDAF for the NTN gNB/sNB.

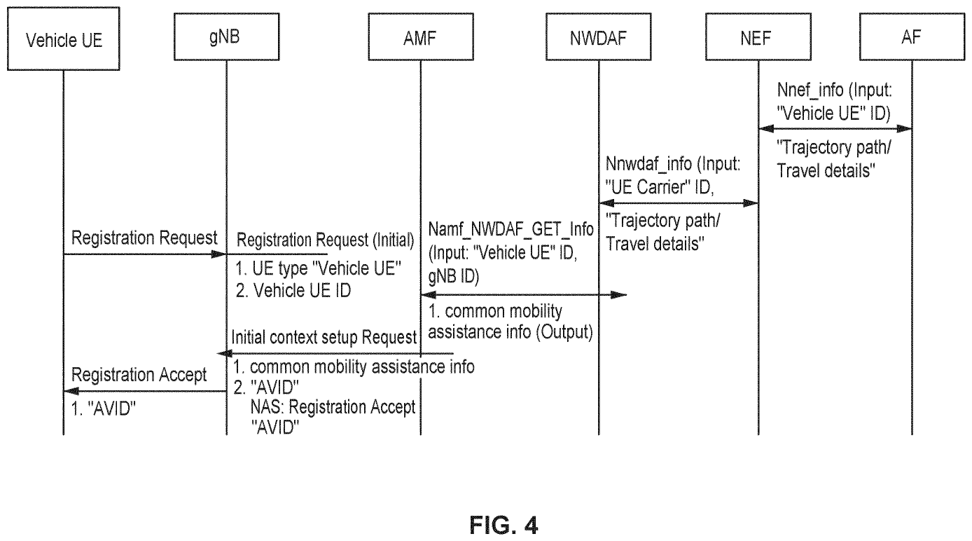

FIG. 4 illustrates a registration procedure for a user equipment carrier, according to certain embodiments. As shown in FIG. 4, an AF and NEF can exchange information regarding a vehicle having a vehicle UE, which may be an aircraft or other AV. As the vehicle UE may be installed in the vehicle, the path of one may correspond to the path of the other. The exchanged information may include an identifier of the vehicle UE and trajectory path and other travel details of the vehicle UE. The NEF may also exchange such information with the NWDAF or another analytics function.

The vehicle UE can send a registration request to a gNB. The vehicle UE may be installed or otherwise disposed within the vehicle. The gNB can provide a registration request to an AMF, including an identification of the UE type as vehicle UE and a vehicle UE ID. The AMF can query the NWDAF using the vehicle UE ID and receive common mobility assistance information from the NWDAF. The AMF can then provide this common mobility assistance information to the gNB along with an AVID. The gNB can provide the AVID to the vehicle UE.

Using the pre-determined aircraft trajectory path or travel details can be accomplished by the AF preconfiguring trajectory path information for a vehicle UE.

The AF, which may be managed by the air service or ship service operator, can configure the vehicle UE information and the related trajectory path at the NEF, which can forward to the appropriate NWDAF. The aircraft or the cruise ship can be fitted with the UE. This device of the transportation vehicle can be defined as new UE type, vehicle UE.

When this UE triggers a registration procedure, the UE can indicate the new UE type, vehicle UE. The AMF can provide the vehicle UE identifier and the current serving gNB ID to the NWDAF. The NWDAF can do the analytics and can provide the common mobility assistance information indicating the list of probable NTN gNB/cells or PLMN that could serve the vehicle UE based on its predefined path. The NWDAF/AF can considers the ephemeris data obtained earlier to derive the assistance information.

Alternatively, AMF can calculate the common mobility assistance information on its own. The AMF can assign an AVID to the vehicle UE in the registration accept and can also indicate the common mobility assistance information obtained from NWDAF to the NTN gNB.

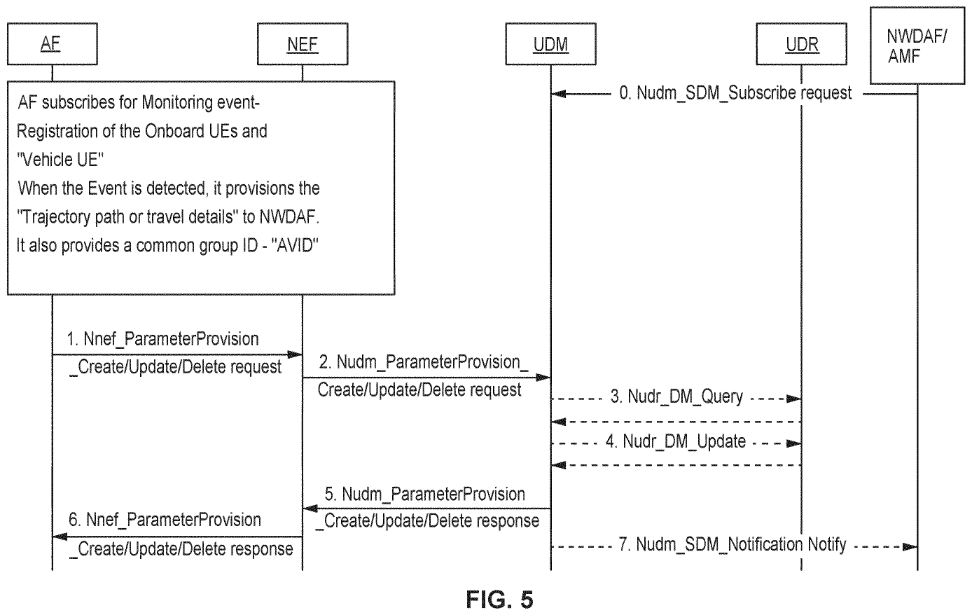

FIG. 5 illustrates provision of travel details and common group identifier for user equipment traveling together, according to certain embodiments. As shown in FIG. 5, the NWDAF/AMF can provide a subscribe request to a UDM at 0. Meanwhile, the AF can subscribe for a monitoring event. The monitoring event can be the registration of the onboard UEs and the vehicle UE. When the event is detected, the AF can provision the trajectory path or travel details to the NWDAF and can also provide a common group ID, AVID. As shown in FIG. 5, the AF can communicate with the UDM via the NEF at 1 and 2. The UDM can coordinate at 3 and 4 with the unified data repository (UDR) and can notify the NWDAF/AMF at 7. Responses to the AF can be provided by the UDM to the AF via the NEF at 5 and 6.

Thus, FIG. 5 can relate to the binding of aircraft with the onboard passengers having user equipment devices. In this example, the AF can provide trajectory path information of the vehicle UE, as well as common group ID, AVID, to the network. Thus, the AF can provide the travel details and common group ID for UEs travelling together to the network

As indicated, the AF, which may be provided by the aircraft service provider, can have subscribed for monitoring the event of registration of the vehicle UE and other onboard UEs. When the UEs registers with the network, the AF can be updated about the event. The AF can provide the trajectory path or travel details of the UE to the network (either AMF or NWDAF) and can also provide a common group ID AVID to the AMF. There are some independent configurations that AF can provide to the network. The travel information parameter(s) can also similarly be configured by the AF in advance to provide better service to users. Here, the network may not request the AF for the path/details, in which case a trigger may be needed. Instead, the AF can configure based on its knowledge about users using its service, for example based on confirmed users who have booked tickets for a certain flight between two cities.

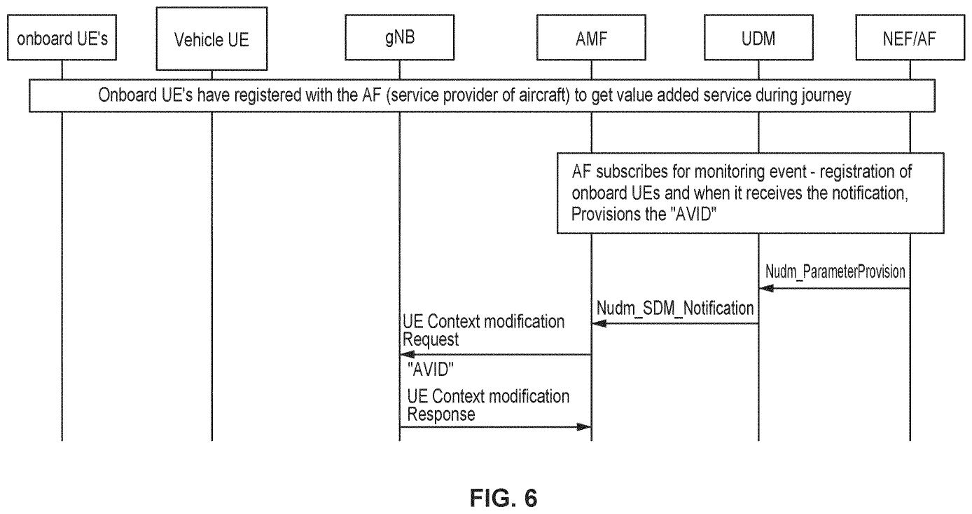

FIG. 6 illustrates an application provisioning a common identifier, such as a common vehicle identifier for all onboard UEs, according to certain embodiments. As shown, an AF can provide the common group ID, AVID, for UEs travelling together. Assuming onboard UEs register with the AF managed by the aircraft service provider to receive value added service during the travel, the AF can assign an AVID to all the onboard UEs based on travel details. The AF can also update the NTN AMF. The AMF can inform the RAN about the common AVID to the associated UEs via a UE context modification procedure.

Thus, for example, onboard UEs may register with an AF provided by the service provider of the aircraft, such as the airline. The user of the UE may be incentivized to register to get value added service during journey. As mentioned above with reference to FIG. 5, the AF can subscribe for monitoring an event of the registration of the onboard UEs. When the AF receives notification of registration, the AF can provision the AVID. The AMF can provide the AVID to the gNB in a context modification request, as mentioned above.

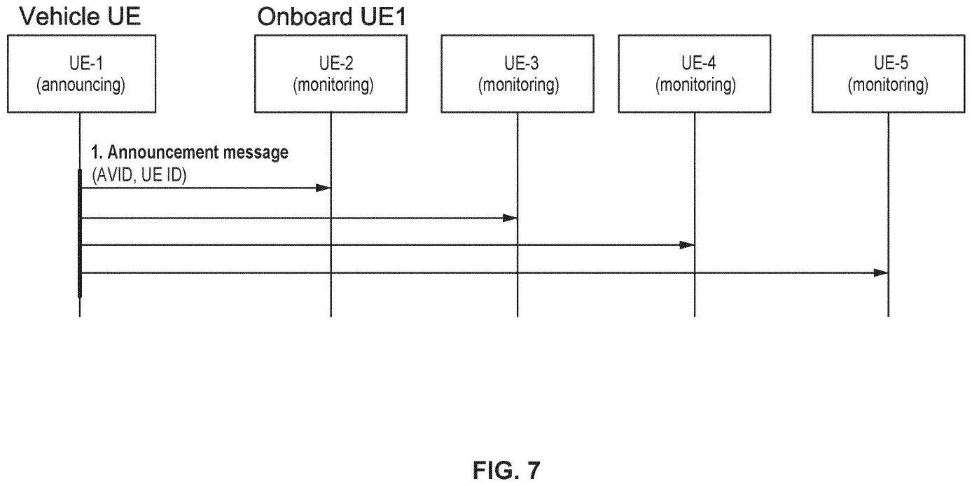

FIG. 7 illustrates a proximity services discovery procedure, according to certain embodiments. Certain embodiments may relate to ways that a network can associate the onboard UEs based on AVID or current TAC. Thus, FIG. 7 illustrates a model A based proximity services (ProSe) discovery procedure.

The vehicle UE, UE-1, in FIG. 7 may send an announcement message that includes the AVID assigned to the vehicle, such as the aircraft. Thus, the onboard UEs, UE-2, UE-3, UE-4, and UE-5 may be informed by UE-1 of the AVID.

During vehicle UE registration with the network, the network can assign AVID to the vehicle UE. Onboard UEs and the vehicle UE, all of which may be ProSe capable, may be authorized to communicate over PC5 with an authorized service code. Model A can use a single discovery protocol message, an announcement, based on the PC5 interface between UEs. Onboard UEs may optionally establish a connection for one-to-one ProSe direct communication with the vehicle UE based on the announcement message and can receive the AVID, which the UEs can use during their registration procedures with the network.

Although FIG. 7 illustrates an example of a vehicle UE ID being distributed via ProSe directly, there are other ways that the vehicle UE ID can be distributed. For example, the vehicle UE ID can be distributed by AF to NEF to AMF/NWDAF to the UE. Other distribution mechanisms are also permitted.

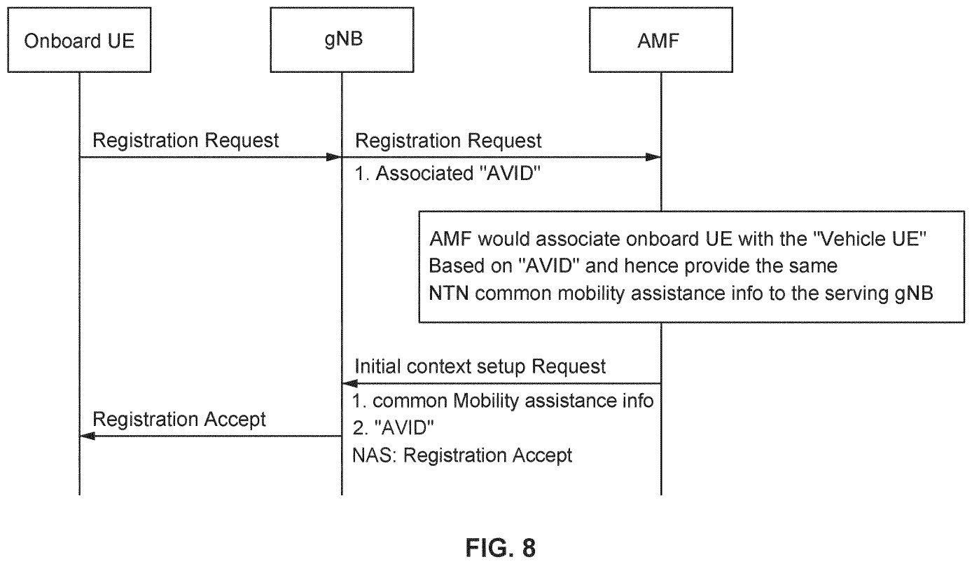

FIG. 8 illustrates a registration procedure of an onboard user equipment, according to certain embodiments. The onboard UE registration procedure, as shown, can involve the onboard UE sending a registration request to the gNB. The gNB can send the registration request with an associated AVID to the AMF. The AMF can associate the onboard UE with the vehicle UE based on AVID and hence can provide the same NTN common mobility assistance information to the gNB. The gNB receiving this information can send a registration accept to the onboard UE.

Based on vehicle UE discovery by the onboard UEs using model A ProSe discovery procedure, the onboard can obtain the AVID assigned to the vehicle UE. The onboard UE can indicate the associated AVID and the onboard UEs current location, as TAC, in the registration request to the AMF. Based on the AVID and/or TAC, the AMF may group the onboard UEs along with the vehicle UE and may indicate the same common mobility assistance information and AVID assigned to vehicle UE to the onboard UE as well in the Initial context setup request. This information may enable the RAN to be aware of the association of the vehicle UE and onboard UEs and may use the info during mobility management of the onboard UEs.

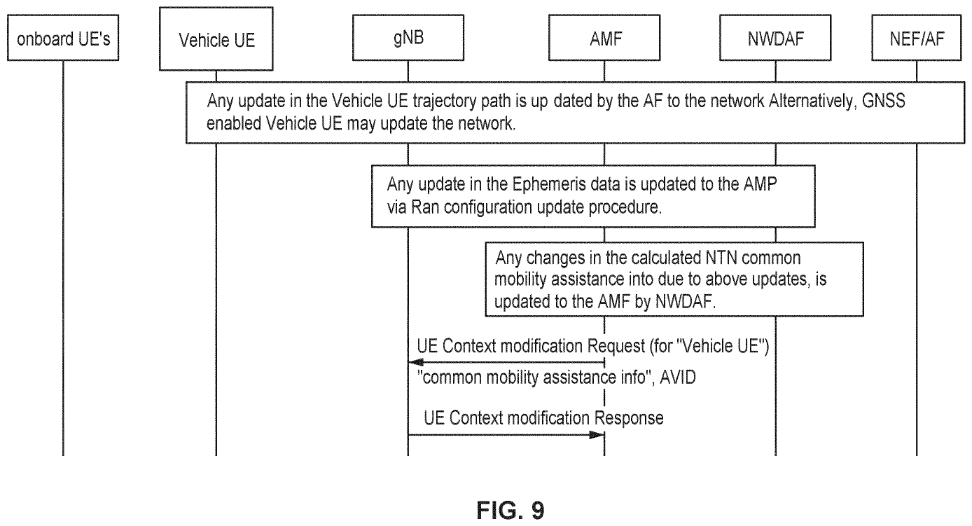

FIG. 9 illustrates updating common mobility assistance information, according to certain embodiments. More particularly, FIG. 9 illustrates a dynamic update in common mobility assistance information. When there is an update in the vehicle UE trajectory path, the AF can update the NWDAF via the NEF. The NWDAF can update the AMF with updated common mobility assistance information.

Alternatively, a global navigation satellite system (GNSS) enabled vehicle UE may update the network with any change in the path, which may be indicated to the NWDAF to calculate new value of common mobility assistance information. As indicated earlier, if there is update in NTN gNB ephemeris data, that can be updated via RAN configuration update procedure. Based on these updates, if the NWDAF calculates a new value of common mobility assistance information, the NWDAF can update the AMF, which can update the UE context at the gNB for the vehicle UE and can indicate the AVID based on which gNB can use the updated info for all the applicable associated UEs.

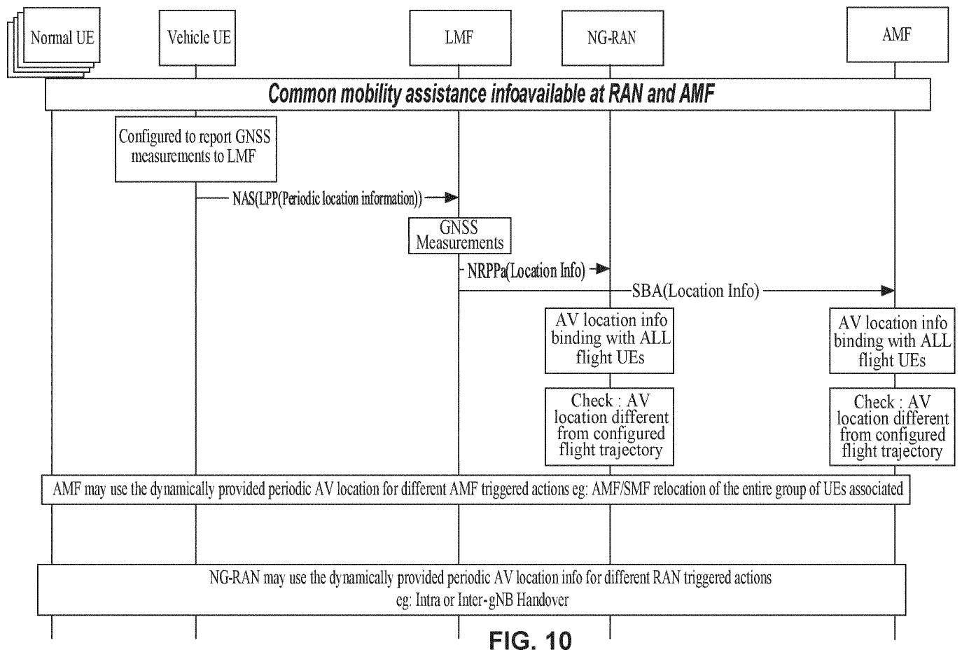

FIG. 10 illustrates usage of common mobility assistance information, according to certain embodiments. As shown in FIG. 10, common mobility assistance information can be used in NG-RAN and CN. More specifically, FIG. 10 illustrates application of vehicle UE location information at NG-RAN and AMF. The flow in FIG. 10 starts from a point at which common mobility assistance information is available at the RAN and AMF. The normal UEs illustrated in this figure may be onboard UEs that are onboard the vehicle with the vehicle UE. The vehicle UE may be configured to report GNSS, broadly including global positioning system (GPS) measurements, to the LMF. These may be provided in non-access stratum as periodic location information. The LMF may store these GNSS measurements and provide location information to the NG-RAN in an NRPPa message.

The LMF can also provide location information to the AMF. The NG-RAN and AMF can each perform AV location information binding with all flight UEs. They can also check if the AV location is different from configured flight trajectory.

The AMF may use the dynamically provided periodic AV location for different AMF triggered actions. For example, there can be AMF/SMF relocation of the entire group of UEs associated with the AVID. Additionally, NG-RAN may use the dynamically provided periodic AV location info for different RAN triggered actions. For example, the NG-RAN can use the information for intra-or Inter-gNB handover.

If FIG. 10, the vehicle UE is shown as being configured to report GNSS measurements to LMF. The LMF may be configured by the AMF and NG-RAN to report the location information periodically. This may enable two aspects. According to one aspect, there can be monitoring whether the flight trajectory/path is different from the pre-programmed one. This may be required to ensure that a dynamic change of location/path is accounted for. According to another aspect, there can be association of the flight location/path with the individual UEs travelling. This may ensure that the network does not need to fetch location information of individual UEs to actuate mobility events.

The CN and RAN may use the common mobility assistance information and the dynamic location updates for their own purposes. For example, the AMF may trigger AMF/SMF relocation when required for the entire group of UEs and the NG-RAN may trigger intra-or inter-gNB HO whenever required.

Since the events are performed for a group of UEs, they can be optimized with respect to resources and time.

Certain embodiments may have various impacts. For example, in certain embodiments a UE within a vehicle may be able to indicate the UE's vehicle UE ID, of which the AV discussed above may be an example. The NWDAF may, in certain embodiments, have the ability to calculate common mobility assistance information based on the NTN gNB ephemeris data and vehicle UE trajectory path information, such as Cell ID/TA. The NWDAF may also have the ability to translate the vehicle trajectory path information into Cell ID/TA.

The NEF may have the ability to translate the vehicle trajectory path information into Cell ID/TA to the NWDAF. Moreover, the AMF may have the ability to provide the common mobility assistance information from NWDAF to NTN gNB. Furthermore, an NTN gNB may have the ability to use the common mobility assistance information and vehicle group identifier (VGID) provided by the AMF to aid in the connected mode mobility procedures for the group of UEs onboard the vehicle.

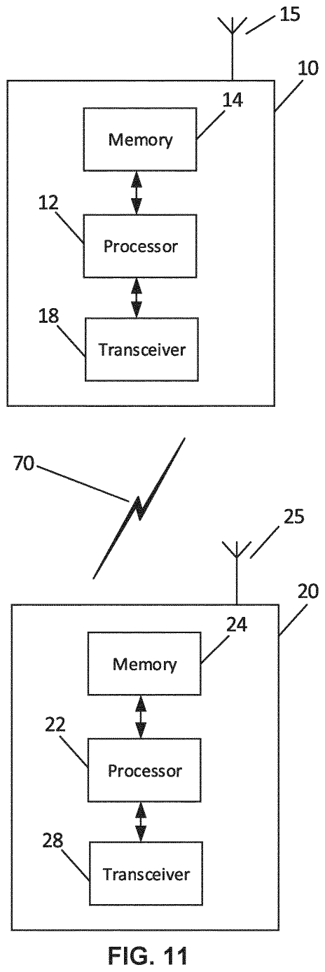

FIG. 11 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 11.

As illustrated in the example of FIG. 11, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IOT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 3-10, or any other method described herein. In some embodiments, as discussed herein, apparatus 10 may be configured to perform a procedure relating to providing connected mode mobility management for aerial vehicle/cruise ship and non-terrestrial network deployments, for example.

FIG. 11 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IOT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 20 may include components or features not shown in FIG. 11.

As illustrated in the example of FIG. 11, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 3-10, or any other method described herein. For example, in an embodiment, apparatus 20 may be controlled to perform a process relating to providing connected mode mobility management for aerial vehicle/cruise ship and non-terrestrial network deployments, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, in certain embodiments mobility of onboard user equipment being served by a non-terrestrial network may be enhanced or optimized. For example, use of an expected trajectory of the user equipment may facilitate appropriate handover.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

5GS 5G System
AMF Access and Mobility Management Function
IoT Internet of Things
NEF Network Exposure Function
NF Network Function
NGAP Next Generation Application Protocol
NRF Network Repository Function
(R)AN (Radio) Access Network
SMF Session Management Function
UAS Unmanned Aerial System
UAV Unmanned Aerial Vehicle
UDM Unified Data Management
UPF User Plane Function
UDR Unified Data Repository
NSSAI Network Slice Selection Assistance Information

1-87. (canceled)

88. An apparatus, comprising:
at least one processor; and at least one memory storing instructions that, when executed by the at least one processor, cause the apparatus at least to:
obtain, from a vehicle user equipment, an identifier assigned to the vehicle user equipment; and
register for services with a network, wherein the registering comprises providing the identifier to the network in the registration request.

89. The apparatus of claim 88, wherein the identifier is obtained in a proximity services discovery procedure.

90. The apparatus of claim 88, wherein the identifier is obtained from an application function.

91. An apparatus, comprising:
at least one processor; and at least one memory storing instructions that, when executed by the at least one processor, cause the apparatus at least to:
receive, from a vehicle user equipment, a non-access stratum message with a registration request;
send the registration request to a control plane function of a core network, wherein the registration request comprises an identifier of the vehicle user equipment; and
receive an initial context setup request in response to the registration request, the initial context setup request comprising common mobility assistance information corresponding to the identifier.

92. The apparatus of claim 91, wherein the apparatus is further caused to:
receive the identifier from a control plane function in a user equipment context modification request.

93. An apparatus, comprising:
at least one processor; and at least one memory storing instructions that, when executed by the at least one processor, cause the apparatus at least to:
receive a request to provide common mobility assistance information associated with an identifier of a vehicle user equipment; and
provide the common mobility assistance information to a control plane function in response to the request.

94. The apparatus of claim 93, wherein the apparatus is further caused to:
obtain, from a network exposure function, trajectory path or travel details corresponding to the user equipment associated with the identifier, wherein the common mobility assistance information is based on the trajectory path or travel details.

95. The apparatus of claim 94, wherein the apparatus is further caused to:
receive an update to the trajectory path or travel details or to ephemeris data of a serving radio access network node; and
update the common mobility assistance information based on the update to the trajectory path or travel details or to the ephemeris data.
